(19) United States
(12) Patent Application Publication
(10) Pub. No.: US 2026/0205821 A1
(43) Pub. Date: Jul. 16, 2026

(54) Mobile Device Location-Based Authentication

(71) Applicant: Private Tech, Inc., Arlington, VA (US)

(72) Inventors: John McKinstry Doyle, Arlington, VA (US); Stephen James Dowhy, Arlington, VA (US); Sihua Maurice Zhang, Arlington, VA (US)

(21) Appl. No.: 19/445,498

(22) Filed: Jan. 10, 2026

Related U.S. Application Data
(60) Provisional application No. 63/743,786, filed on Jan. 10, 2025.

(51) Int. Cl. H04W 12/63; H04W 12/06; H04W 84/04

(52) U.S. Cl. CPC H04W 12/63; H04W 12/06; H04W 84/042

(57) ABSTRACT

Disclosed is a method of authenticating the location of a mobile device includes a storing a last connected time and a last connected location of a mobile device on a home network, receiving, by the home network, a request to register the mobile device on the roaming network, calculating a distance between the last connected location and a location of the roaming network, calculating an elapsed time between the last connected time and a time of the request, determining whether the distance could be reasonably traveled in the elapsed time, requesting by the home network, a location information of the mobile device, and determining whether the location information of the mobile device is consistent with a PLMN of the roaming network.

### BACKGROUND OF THE INVENTION

This application is a continuation-in-part of U.S. Application 63/743,786 filed January 10, 2025 the entirety of which is hereby incorporated by reference.

### Field of the Invention

The embodiments of the invention relate to a method of authenticating electronic messages in a low-trust or zero-trust environment, and more particularly, to a method of authenticating roaming registration requests submitted by a roaming network to permit a mobile device to roam on the roaming network. Although embodiments of the invention are suitable for a wide scope of applications, it is particularly suitable for authenticating potentially false roaming registration requests from a roaming network.

### Discussion of the Related Art

Roaming in mobile networks may be implemented through a combination of signaling protocols, database queries, and inter-network agreements that enable a subscriber to access services outside their home network coverage area.

When a mobile device moves into a visited network's coverage area, the device may detect available networks by scanning for broadcast signals from base stations. Upon identifying a suitable visited network, the device may attach to the visited network and attempt registration by transmitting its identity credentials, which typically include the International Mobile Subscriber Identity (IMSI) stored on the subscriber identity module (SIM).

The visited network's mobility management entity or mobile switching center may receive the registration request and query its visitor location register (VLR) or mobility management entity (MME) to determine whether the subscriber has existing records. In cases where no local record exists, the visited network may initiate registration with the subscriber's home network. This communication may occur over standardized interfaces such as the SS7 signaling network in legacy systems or the Diameter protocol in LTE and newer architectures. The home network may provide the visited network with the subscriber's service profile, which defines permitted services, quality of service parameters, and billing arrangements.

The home network may update its records to reflect the subscriber's current location in the visited network, enabling incoming calls and messages to be routed to the visited network. A tunneling mechanism may be established for data services, where user plane traffic may be routed through a gateway in either the home network or the visited network depending on the roaming agreement type, such as home-routed roaming or local breakout configurations.

Billing records may be generated by the visited network and transmitted to a clearinghouse or directly to the home network for settlement according to inter-operator tariff agreements.

But there are weaknesses in the current roaming systems because a malicious network may falsely claim that a subscriber is roaming. In such attack scenarios, a compromised or fraudulent network operator may transmit signaling messages to the home network asserting that a subscriber has registered within its coverage area when the subscriber has not actually done so. This false roaming claim may exploit the trust relationships inherent in inter-operator signaling protocols, where networks traditionally accept location update messages from peer networks without independent verification.

The consequences of such fraudulent roaming claims may be significant. The home network, upon receiving the false location update, may redirect incoming calls and messages intended for the subscriber to the malicious network, potentially enabling interception of sensitive communications. Additionally, the malicious network may generate fabricated billing records for services purportedly consumed by the subscriber, resulting in fraudulent charges being assessed against the subscriber's account or the home network being obligated to pay settlement fees for services never rendered.

Furthermore, the false roaming registration may cause the home network to update its location registers with incorrect information, potentially disrupting legitimate service delivery to the subscriber. The subscriber's actual serving network may be unaware that the home network believes the subscriber to be located elsewhere, leading to routing failures for mobile-terminated services. In some implementations, the malicious network may also request and receive authentication vectors from the home network, which could be exploited to impersonate the subscriber or establish unauthorized sessions.

The vulnerability may be exacerbated by the limited mechanisms available in conventional roaming architectures for the home network to independently verify whether a subscriber is genuinely present in a claimed visited network. Traditional signaling protocols may lack robust provisions for location attestation or cryptographic proof of subscriber presence, creating opportunities for exploitation by malicious actors with access to inter-operator signaling infrastructure.

By way of example, a threat actor can use a compromised network to obtain two-factor authentication codes. The attack may begin with the threat actor obtaining a user name and password for a mobile subscriber’s bank account through traditional hacking or phishing techniques. If the threat actor also has access to a compromised mobile network, the threat actor can cause the mobile subscriber’s device to register with the visiting network through existing protocols. The threat actor may then attempt to access the mobile subscriber’s bank account through the Internet. In the event that the bank website attempts two-factor authentication by sending an authentication code through text message, the text message is routed to the compromised network where it can be retrieved by the threat actor.

There are great difficulties in addressing the weaknesses of the current roaming technologies because cell phone systems are operating in accordance with standardized protocols and any updates to protocols would require adoption of new protocols by standards bodies and subsequent adoption by mobile providers.

Accordingly, there are weaknesses in current systems for permitting a mobile subscriber to roam on a visiting network. There is a need for more robust security measures by the home network to ensure that received roaming registration requests are the result of authentic mobile subscriber activity rather than the malicious conduct of a threat actor.

### SUMMARY OF THE INVENTION

Accordingly, embodiments of the invention are directed to a method of authenticating the location of a mobile device that substantially obviates one or more of the problems due to limitations and disadvantages of the related art.

An object of embodiments of the invention is to provide an improvement to roaming protocols.

Another object of embodiments of the invention is to provide proof from the mobile device, that it is intending to roam

Yet another object of embodiments of the invention is to provide a mechanism for a mobile device to report its location to its home network without actually transmitting its location coordinates to the network.

Still another object of embodiments of the invention is to provide a secure method of communication between a mobile device and its home network for authenticating roaming requests.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, a method of authenticating the location of a mobile device includes a storing a last connected time and a last connected location of a mobile device on a home network, receiving, by the home network, a request to register the mobile device on the roaming network, calculating a distance between the last connected location and a location of the roaming network, calculating an elapsed time between the last connected time and a time of the request, determining whether the distance could be reasonably traveled in the elapsed time, requesting by the home network, a location information of the mobile device, and determining whether the location information of the mobile device is consistent with a PLMN of the roaming network.

In another aspect, a method of authenticating the location of a mobile device includes a attaching the mobile device to the roaming network; receiving an authentication request from the home network; encrypting an identifier with a private key of the mobile device; and sending the encrypted identifier and a location information of the mobile device to the home network.

In yet another aspect, a method of authenticating the location of a mobile device includes storing a last connected time and last connected location of a mobile device on a home network, receiving, by the home network, a request from the roaming network pertaining to the mobile device, calculating a distance between the last connected location and the roaming network, calculating an elapsed time between the last connected time and a time of the request, determining whether the distance could be reasonably traveled in the elapsed time, provisionally directing limited data services for the mobile device to the roaming network to conduct further authentication, requesting by the home network, a location information of the mobile device, receiving the location information and an encrypted identifier from the mobile device, decrypting the encrypted identifier to authenticate the received location information, and determining whether the location information is consistent with a PLMN of the roaming network.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1 is a flow chart of authenticating roaming requests by a mobile network according to an exemplary embodiment of the invention; and

FIG. 2 is a flow chart of authenticating roaming requests by a mobile device according to an exemplary embodiment of the invention.

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

Embodiments of the invention are performed substantially by software. The software may be executed by one or more processors within network infrastructure components, including but not limited to servers, routers, gateways, mobility management entities, home subscriber servers, and other network elements involved in roaming authentication and verification procedures. The processors may comprise general-purpose central processing units, specialized digital signal processors, application-specific integrated circuits, field-programmable gate arrays, or combinations thereof configured to execute programmed instructions.

The software implementing embodiments of the invention may be stored on non-transitory computer-readable storage media, which may include magnetic storage devices such as hard disk drives, solid-state storage devices including flash memory and solid-state drives, optical storage media, or other persistent storage technologies. The computer-readable storage media may be integral to the network equipment or may be accessible via network connections to remote storage systems.

In some embodiments, the software may be distributed across multiple network nodes, with different functional components executing on different physical or virtual machines. The software components may communicate via standardized interfaces and protocols, including application programming interfaces, message queues, or remote procedure calls. Virtualization technologies may be employed, wherein the software executes within virtual machines or containerized environments hosted on physical server infrastructure.

The software may be implemented in various programming languages and may utilize existing software libraries, frameworks, and protocol stacks for network communication, cryptographic operations, and database interactions. Updates to the software may be deployed to network equipment through over-the-air updates, remote management systems, or manual installation procedures, enabling the invention to be implemented on existing network infrastructure through software upgrades without requiring replacement of hardware components.

Embodiments of the invention seek to solve a weakness in modern roaming protocols, namely that mobile network providers are generally presumed to be trustworthy and, accordingly, requests from other mobile networks to register a mobile device to roam are subjected to very basic authentication. Thus, it is possible for a rouge network operator to “hijack” a mobile device by submitting fraudulent roaming requests to the mobile network. The invention provides authentication steps to ensure that the mobile device is truly seeking to roam.

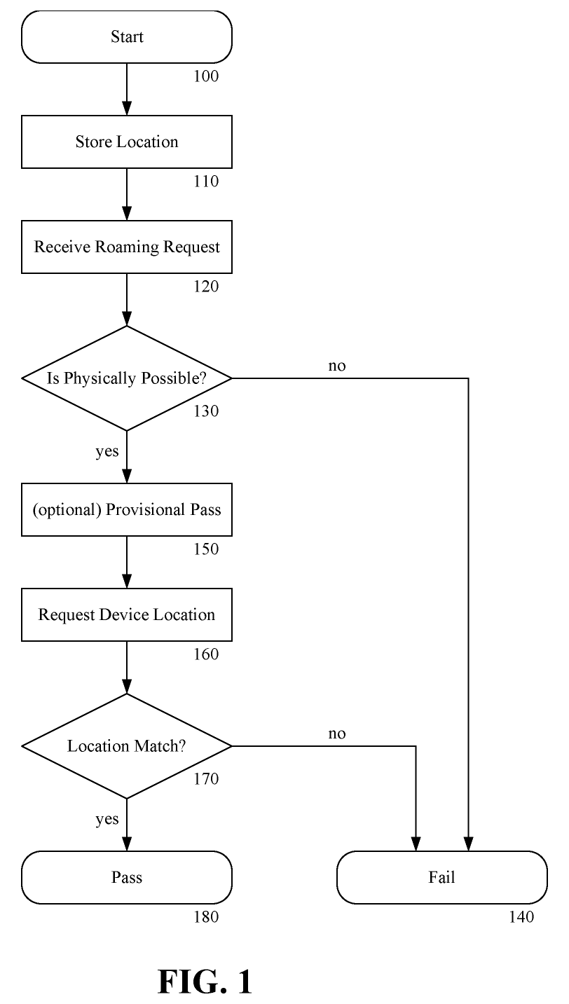

FIG. 1 is a flow chart of authenticating a roaming request by a mobile network according to an exemplary embodiment of the invention. As shown in FIG. 1, authenticating a roaming request by a mobile network includes storing a location step 110, receiving a roaming request step 120, physically possible decision step 130, optional provisional registration step 150; request device location step 160, and location match decision step 170. The process can end in authentication pass 180 or authentication fail 140.

The process can start in step 100. Before the process starts, a mobile device may be attached to and registered with their home network. Communications with the mobile device can occur directly between the mobile device and the home network infrastructure (e.g. towers, servers, and data lines).

In step 110, the home network can save a location of the mobile device. The location can be a precise location such as GPS coordinates or other satellite assisted location. The approximate location may be a postal code or generalized geographic area. The location can be described as location information and may include a precise location, approximate location, or information that represents either of the foregoing.

The location can be an approximate location determined based on the relative signal strength of surrounding cell phone towers. Approximate location determination from tower signal strengths may be performed through triangulation or trilateration techniques using measurements from multiple base stations within range of the mobile device. When a mobile device is connected to a cellular network, the device may simultaneously receive signals from several cell towers, each signal exhibiting a received signal strength indicator (RSSI) value that correlates inversely with the distance between the device and the respective tower.

The home network may maintain a database containing the geographic coordinates of each base station within its infrastructure. When the mobile device reports the identities and corresponding signal strength measurements of visible towers, the home network may calculate estimated distances from each tower based on path loss models that account for signal attenuation over distance. By combining the estimated distances from three or more towers with known positions, the network may compute an intersection region representing the probable location of the mobile device.

In implementations where fewer than three towers are visible, the approximate location may be determined as a circular region centered on the single tower or as an intersection of two circular regions when two towers are available. The radius of uncertainty may vary depending on factors including tower density, terrain characteristics, and signal propagation conditions. Urban environments with high tower density may yield location estimates with accuracy within hundreds of meters, while rural areas with sparse tower coverage may produce estimates accurate only to several kilometers.

The home network may store the approximate location as a geographic region, postal code, or set of coordinates with an associated uncertainty radius, enabling subsequent comparison against the claimed location of roaming networks during authentication procedures. The location can be stored in a database on the home network. At some point, a mobile device may become disconnected from the network, for example, if the user of a mobile device traveled overseas on an airplane.

In step 120, the home network may receive a registration request from a roaming network. This may occur, for example, if the user of the mobile device turned on their mobile device after a flight and the mobile device automatically attempted to connect to available networks. Upon receiving a registration request from the mobile device, the roaming network will send a registration request to the home network requesting, among other things, that mobile services for the mobile device be directed to the roaming network.

In decision step 130, the home network provides a first authentication step to determine whether it would be physically possible for the mobile device to be physically present in the geographic area of the roaming network based on the stored location from step 110. For example, if the stored location was Washington, DC at 2:00 pm and the home network received a roaming request from Algeria at 3:00 pm, the home network can determine that it would be physically impossible to travel that distance in one hour, refuse registration of the mobile device on the roaming network, and the authentication process would proceed to fail step 140. Alternatively, if the home network determines it would be physically possible to travel the distance between the last known location of step 110 to the area of the roaming network, then the authentication process can proceed to optional step 150.

The location of the roaming network can be determined based on methods known in the art such as the country code or network identifier of the Public Land Mobile Network (PLMN) for the roaming network. Under current protocols, the PLMN of the roaming network is sent to the home network together with the registration request.

The PLMN can cover a large area and can be a fast, but imprecise way to provide authentication. For example, where roaming networks are adjacent, such as on the boarder of the United States and Mexico, a mobile device in the United States spontaneously roam to a Mexican service provider if a United States based signal is weak.

In optional step 150, the mobile device can be provisionally registered on the roaming network. Under provisional registration, the home network may authorize limited data services to the mobile device on the roaming network for the purposes of conducting additional authentication steps. Under provisional authentication, voice and data services for the mobile device may initially be maintained with the home network, but certain traffic relating to authentication according to embodiments of the invention may be routed to the roaming network. If optional step 150 is omitted, the additional authentication steps may occur over another data connection such as satellite, private network, or WiFi.

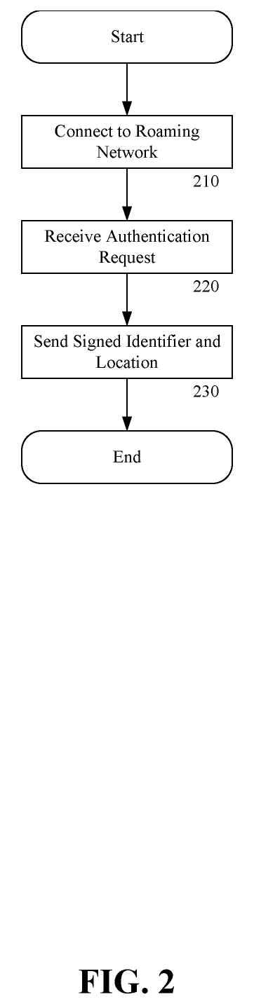

In step 160, the home network can request the mobile device to report its location. The mobile device can respond and send its location or other location information to the home network. Communication between the home network and the mobile device will be more particularly described in conjunction with FIG. 2.

In decision step 170 the location reported by the mobile device can be compared against the PLMN of the roaming network. If the location reported by the mobile device is inconsistent with the PLMN, the authentication can fail and the process can terminate in fail step 140. If limited data services were provisionally authorized in step 150, those data services can be revoked. Alternatively, if the location reported by the mobile device is within the area of the PLMN, the authentication can pass and the process can terminate in pass step 180.

Although preferred embodiments of the invention describe authentication in terms of verifying a location, location information can include any information about the location of the mobile device which can be used to verify the authenticity of a roaming request from a roaming network. For example, location information received from in response to the location request of step 160 may be a hardware identifier of a tower that the mobile device is connected to. Because towers are generally stationary, the home network can maintain a private database of such hardware identifiers, their locations, and the identities of the mobile networks such towers serve. Thus, if a roaming request is received indicating PLMN ‘X’ and the mobile device reports it is connected to a tower having a hardware identifier known to be a part of PLMN ‘X’, then the roaming request can be authenticated as valid and the process can proceed to pass step 180.

In pass step 180, the home network can permit full, non-provisional registration of the mobile device on the roaming network and forward voice and data communications for the mobile device to the roaming network.

FIG. 2 is a flow chart of authenticating roaming requests by a mobile device according to an exemplary embodiment of the invention. As shown in FIG. 2, authenticating a roaming request by a mobile device includes connecting to a roaming network 210, receiving an authentication request 220, and sending an encrypted identifier and location 230.

In process step 210, a mobile device can attach to and attempt registration with a roaming network. Mobile devices are generally configured to connect to a home network if available. If the home network is unavailable, the mobile device may attempt to connect to other available networks. Networks other than a home network can be called a roaming network or visited network. Upon attaching to a roaming network, the roaming network will send a registration request to the home network seeking authorize for services for the mobile device on the roaming network. See, e.g. FIG. 1, step 120. The request to the home network can include the PLMN of the roaming network and the International Mobile Subscriber Identity (IMSI) of the mobile device.

In process step 220, an authentication request can be received by the mobile device from the home network. The authentication request can seek additional information pertaining to whether the mobile device is truly seeking to roam on the roaming network. The authentication request can include a nonce that the mobile device can use in responses for further authentication. The authentication request can alternatively include other nonce-like non-sensitive data such as a date stamp or a MAC address of the home network.

In process step 230, the mobile device can sign the nonce or nonce-like data with a private key stored on the mobile device. The mobile device can send the signed nonce and encrypted location information back to the home network. The home network can validate the signed nonce using a known public key associated with the mobile device to reveal the original, plaintext nonce thereby verifying that the message originated from the mobile device.

In some embodiments of the invention, the location information can be omitted from the response to the home network and only the encrypted nonce can be returned. An encrypted nonce, only, can be interpreted to be a confirmation of the roaming request from the mobile device to the home network. In that way, location information of the mobile device is not transmitted over the network – whether encrypted or not – only a signal that the device is intending to roam on the roaming network. In other embodiments of the invention, the mobile device can sign and return only the public key of the home network as a verification to the home network that the mobile device is indeed attached to the roaming network.

The location information sent to the home network can be GPS coordinates of the mobile device. The location information sent the home network can be an approximate location such as a postal code or radius. The location information can be an identifier of a tower that the mobile device is connected to such as a hardware address. The location information can be the identity and signal strengths of towers visible to the mobile device. The home network can use the location information to deduce whether the mobile device is truly seeking service on the roaming network.

For example, if the home network receives a roaming request from a roaming network in Argentina, but the mobile device reports its location as Ecuador, the home network can refuse to provision services on the roaming network.

Before the electronic device is fully provisioned on the roaming network, communication between the mobile device and the home network can be conducted over an alternate communications medium such as Wifi, private network, or a satellite text message. In some embodiments, upon receiving a request for roaming on a roaming network, the home network can provisionally authorize limited data services on the roaming network. Under provisional authorization, existing voice and data services can be left intact while data services relating authenticating roaming registration can be directed to the roaming network.

Embodiments of the invention can use asymmetric encryption for communications between the mobile device and the home network. Encryption keys can be generated during the original provisioning of the mobile device on the home network.

Asymmetric cryptography may employ a pair of mathematically related keys for each entity participating in secure communications. The key pair may comprise a public key, which may be freely distributed and made available to other parties, and a private key, which may be kept secret and known only to the key owner. The mathematical relationship between the keys may be such that data encrypted with one key of the pair can only be decrypted with the corresponding other key of the pair.

In encryption operations, a sender wishing to transmit confidential information to a recipient may obtain the recipient's public key and use it to encrypt the plaintext message, producing ciphertext that can only be decrypted by the holder of the corresponding private key. This arrangement may enable secure communication without requiring the parties to have previously exchanged a shared secret key through a secure channel, addressing the key distribution problem inherent in symmetric cryptography systems.

The security of public key cryptography may rely on computational asymmetry, wherein certain mathematical operations may be easy to perform in one direction but computationally infeasible to reverse without knowledge of the private key. Common mathematical foundations for public key systems may include the difficulty of factoring large prime numbers, as employed in the RSA algorithm, or the discrete logarithm problem in finite fields or elliptic curve groups, as utilized in Diffie-Hellman key exchange and elliptic curve cryptography respectively.

In the context of network security and roaming authentication, public key infrastructure can verify the identity of signaling message originators, and protect the confidentiality of sensitive subscriber information transmitted between network operators.

It will be apparent to those skilled in the art that various modifications and variations can be made in a method of authenticating the location of a mobile device without departing from the spirit or scope of the invention. Thus, it is intended that embodiments of the invention cover the modifications and variations of this invention provided they come within the scope of the appended claims and their equivalents.

What is claimed is:

1. A method for authenticating requests from a roaming network, the method comprising:
storing a last connected time and a last connected location of a mobile device on a home network;
receiving, by the home network, a request to register the mobile device on the roaming network;
calculating a distance between the last connected location and a location of the roaming network;
calculating an elapsed time between the last connected time and a time of the request;
determining whether the distance could be reasonably traveled in the elapsed time;
requesting by the home network, a location information of the mobile device; and
determining whether the location information of the mobile device is consistent with a PLMN of the roaming network.

2. The method of claim 1 wherein the request is an update location request (ULR).

3. The method of claim 1 further comprising:
receiving the location information from the mobile device.

4. The method of claim 1 further comprising:
sending a nonce to the mobile device;
receiving an encrypted nonce and the location information from the mobile device; and
decrypting the encrypted nonce.

5. The method of claim 1 further comprising:
directing communications for the mobile device to the roaming network.

6. The method of claim 2 further comprising:
provisionally directing authentication related communications to the roaming network before determining whether the location information of the mobile device is consistent with the PLMN of the roaming network.

7. The method of claim 1 further comprising:
denying the request to register the mobile device on the roaming network when the distance could not be reasonably traveled in the elapsed time.

8. The method of claim 1 further comprising:
deregistering the mobile device from the roaming network if the location information of the mobile device is inconsistent with a PLMN of the roaming network.

9. A method for authenticating requests by a mobile device registered with a home network to receive communications services from a roaming network, the method comprising:
attaching the mobile device to the roaming network;
receiving an authentication request from the home network;
encrypting an identifier with a private key of the mobile device; and
sending the encrypted identifier and a location information of the mobile device to the home network.

10. The method of claim 9 wherein the identifier is a nonce received from the home network.

11. The method of claim 9 wherein the location information includes satellite informed location.

12. The method of claim 9 wherein the location information includes an identifier of a cell tower.

13. The method of claim 9 wherein the authentication request is received via the roaming network.

14. A method for authenticating requests from a roaming network, the method comprising:
storing a last connected time and last connected location of a mobile device on a home network;
receiving, by the home network, a request from the roaming network pertaining to the mobile device;
calculating a distance between the last connected location and the roaming network;
calculating an elapsed time between the last connected time and a time of the request;
determining whether the distance could be reasonably traveled in the elapsed time;
provisionally directing limited data services for the mobile device to the roaming network to conduct further authentication;
requesting by the home network, a location information of the mobile device;
receiving the location information and an encrypted identifier from the mobile device;
decrypting the encrypted identifier to authenticate the received location information; and
determining whether the location information is consistent with a PLMN of the roaming network.

15. The method of claim 13 further comprising:
registering the mobile device with the roaming network; and
directing communications for the mobile device to the roaming network.

16. The method of claim 13 further comprising:
revoking the limited data services when the location information is inconsistent with the PLMN of the roaming network.

17. The method of claim 13 further comprising:
sending a nonce to the mobile device; and
wherein the encrypted identifier is the nonce encrypted by mobile device.

18. The method of claim 13 further comprising:
wherein the received location information is authenticated by comparing the decrypted identifier to a known value of the decrypted identifier.
